(19) United States
(12) Patent Application Publication
(10) Pub. No.: US 2008/0135534 A1
(43) Pub. Date: Jun. 12, 2008

(54) Apparatus and Method to Make a Metal Cell for Furniture, and Metal Cell for Furniture Thus Made

(76) Inventors: Armando Pujatti, Budoia (PN) (IT); Gianluca Burigana, Venezia (IT)

Correspondence Address: FLASTER/GREENBERG P.C.;8 PENN CENTER, 1628 JOHN F. KENNEDY BLVD., 15TH FLOOR, PHILADELPHIA, PA, 19103, US

(21) Appl. No.: 11/663,893

(22) PCT Filed: Sep. 26, 2005
(86) PCT No.: PCT/EP2005/054787

§ 371 Date: Mar. 26, 2007

(30) Foreign Application Priority Data
Sep. 24, 2004 (IT) UD2004A000186

(51) Int. Cl. B23K 37/00; A47B 96/00

(52) U.S. Cl. 219/148; 312/352

(57) ABSTRACT

Apparatus and method to make a metal cell for furniture, which comprises two flanks (12a, 12b, 12c) and a central body (13a, 13b, 13c) located between them. Each flank (12a, 12b, 12c) is provided with a first polygonal base (14a, 14b, 14c) with standardized height (h) and depth (p), and with at least two limbs (15a, 15b, 15c) made on two consecutive sides of the first polygonal base (14a, 14b, 14c). The central body (13a, 13b, 13c) is provided with a second polygonal base (18a, 18b, 18c) and at least a limb (19a, 19b, 19c) made on one side of the second polygonal base (18a, 18b, 18c).

### FIELD OF THE INVENTION

The present invention concerns an apparatus and a method to make a metal cell, preferably made of stainless steel, with which to make furniture used for example in kitchens, restaurants, hospitals, canteens or generally premises where people eat.

The metal cell according to the present invention has a box-like structure and consists of two shaped flanks and a central body, located between the flanks.

The shaped flanks and the central body are made in such a way that the metal cell made does not have in its inner volume any zones in which dust, dirt or organic material can be deposited and included, making the cleaning operations problematical and compromising the general hygienic conditions.

### BACKGROUND OF THE INVENTION

Metal cells are known, made of stainless steel and used to make furniture for eateries or public premises in general, such as hospitals, school or company canteens, or for places where hygiene is particularly important.

Metal cells of a known type which are very widespread generally comprise a back, two flanks and a bottom sole, obtained starting from substantially plane sheets of metal, cut to size, the end limbs of which, during production, are brought close to each other so as to make a box-like structure.

These components are riveted together, or welded together by spot welding, by means of which the overlapping limbs are put between the electrodes, with a determinate pressure, in order to generate a current with high intensity and very short duration, which causes a consequent very rapid heating of the metal in correspondence with said spot. In this way a molten core is generated which allows to obtain in a very short time the desired welding spot.

Metal cells made with known techniques have the disadvantage that the join between the various parts consists of a large number of non-continuous joints, which cause inclusions and deposits of perishable organic material, dirt and dust, which can only be partly removed and with great difficulty. This compromises the hygiene of the article of furniture thus made.

Furthermore, known production techniques do not allow to standardize the measurements of the cells according to a finite plurality of obtainable sizes, nor to be able to rapidly configure the welding equipment as both the type of cell to be obtained varies in terms of hygiene level, and also as the size of the cell to be made varies. In fact, known welding equipment provides to use welding templates with fixed sizes, and also specific for every level of hygiene, therefore, every time either the size or the level of hygiene of the cell is to be changed, it is necessary, in the state of the art, to use a different template, with consequent problems of finding them, storing them, downtimes in setting up the plant, and other problems.

One purpose of the present invention is to achieve an apparatus and to perfect a method to make metal cells for furniture in which the join zones are continuous and do not include zones, such as welding spots between adjacent limbs, where dirt, dust or organic material or other can be deposited.

Another purpose is to obtain an apparatus and a method wherein it is possible to obtain, substantially automatically, with very quick operations to configure the welding templates and with a unified type of working, cells having a plurality of different and substantially standardized sizes, guaranteeing different levels of hygiene according to the specific requirements to be met.

The Applicant has devised, tested and embodied the present invention to overcome the shortcomings of the state of the art and to obtain these and other purposes and advantages.

### SUMMARY OF THE INVENTION

The present invention is set forth and characterized in the main claims, while the dependent claims describe other characteristics of the invention or variants to the main inventive idea.

The present invention concerns the production of modular metal cells, preferably made of stainless steel AISI 304, or suchlike, for furniture used in kitchens, restaurants, canteens, hospitals or eating places in general.

The metal cell according to the present invention comprises two shaped flanks and a central body interposed between them, which, joined together, form a box-like structure of a substantially parallelepiped shape, normally with at least one side open which can then be associated, during the finishing step, with opening doors or flaps, according to the requirements and functions to be assigned to the finished product.

Each flank in turn consists of a polygonal base, normally rectangular, whose standardized size defines at least the height and the depth of the metal cell; of at least two limbs joined to relative perimeter edges of the base; and of corner elements, also joined to the base by welding.

The method to produce the metal cell according to the invention provides a first step in which the flanks are made by means of a respective welding unit and relative welding templates, and a second step in which, with a different welding unit and templates from the first, the flanks are joined to the central body in order to achieve the finished metal cell.

Thanks to this procedure, the steps to produce two metal cells, even different from each other in size and/or class of hygiene, can partly overlap since, when the flanks and central body are being coupled in the second welding template, in the first welding template the components that form the flanks can be loaded, and these can be welded during the steps when the finished metal cell is discharged.

During the assembly position, each flank has the limbs facing towards the central body; the ends of the limbs are welded, advantageously by spot welding, for the whole of their length to the corresponding perimeter edges of the central body, so that the welding beads develop in an intermediate position of the inner volume of the metal cell, and not in correspondence with the edges as happens in furniture produced with known techniques.

The front corner elements are welded to the base in correspondence with its heads facing towards the open side of the metal cell; in a particular solution of the invention, which provides to obtain rayed surfaces over all the inner edges of the furniture, each flank has another component, consisting of a sector profile which closes the spherical corner that forms in correspondence with the edge on the closed side of the inner volume of the metal cells.

According to the invention, the flanks obtainable belong to at least three different types classifiable according to a standardized index, defined hygiene level, which identifies the configuration of the edges of the inner volume, that is, the sharp edge, partly rayed or totally rayed; the type of configuration is connected to the possibility that impurities, dirt or organic deposits may be included in the zone of junction between the components. It is clear that the more rayed edges there are, the greater the ease of cleaning the metal cell and therefore, the lesser the possibility of deposits of dirt and impurities in the inner volume of the cell.

The central body consists of a sheet of stainless steel bent substantially to an L-shape or a C-shape, according to the level of hygiene required, and comprises a base, having a depth equal to that of the base of the flanks and a variable length that is a function of the width of the metal cell that is to be made, and two limbs. These have the same depth as the base of the flanks.

The metal cell is made in a welding apparatus which, as we said, comprises a first welding unit defining a first welding zone, a second welding unit defining a second welding zone, a mobile welding station and a control unit.

In the first welding zone the flanks are made, advantageously a first flank by means of a first welding template and a second flank by means of a second welding template, adjacent to the first.

In the second welding zone, advantageously disposed in proximity with the first so as to minimize the transfer travels in the case of a welding station that is common to the two units, the production of the metal cell is completed by joining the flanks and the central body together.

In a preferential embodiment, all the welding occurs with continuous welding beads that do not form any irregularities or discontinuities on the surface of the inner volume of the metal cell.

### BRIEF DESCRIPTION OF THE DRAWINGS

These and other characteristics of the present invention will become apparent from the following description of a preferential form of embodiment, given as a non-restrictive example with reference to the attached drawings wherein:

FIGS. 1, 2 and 3 show three forms of embodiment of metal cells according to the invention;

FIG. 4 is an exploded view of the metal cell in FIG. 3;

FIG. 5 shows an enlarged detail of FIG. 3;

FIG. 6 is an exploded view of a corner detail of FIG. 5;

FIG. 7 shows in its entirety the equipment to obtain metal cells according to the invention;

FIGS. 8 and 9 show on an enlarged scale two parts of the equipment in FIG. 7.

### DETAILED DESCRIPTION OF A PREFERENTIAL FORM OF EMBODIMENT

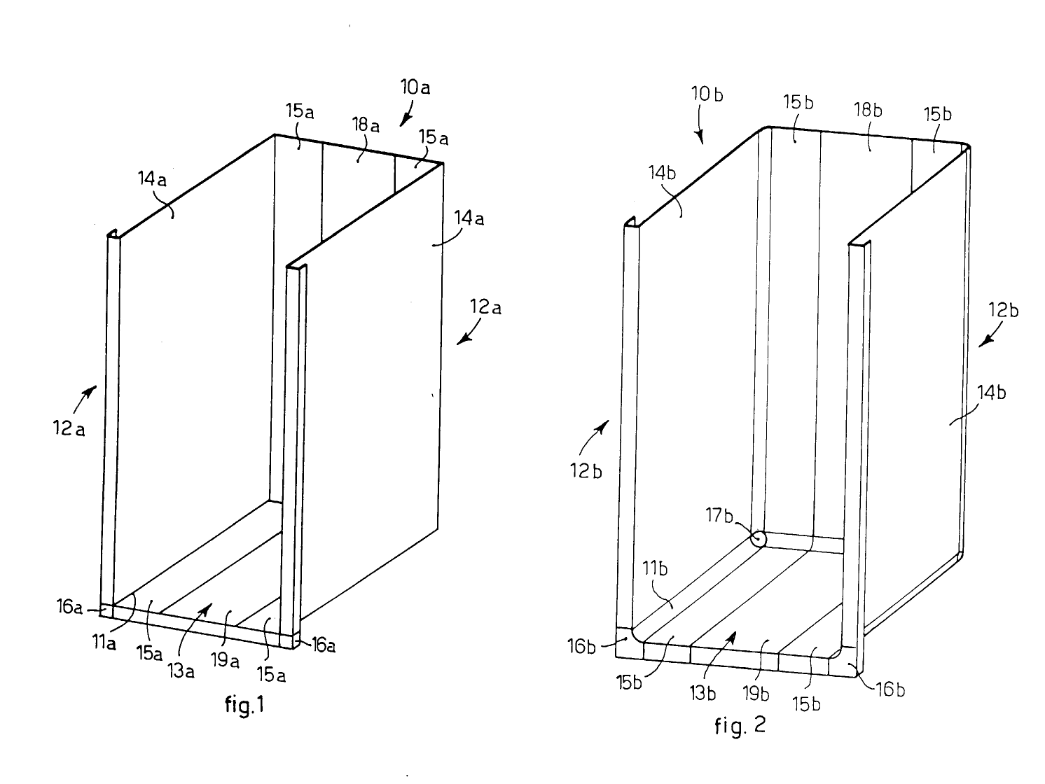

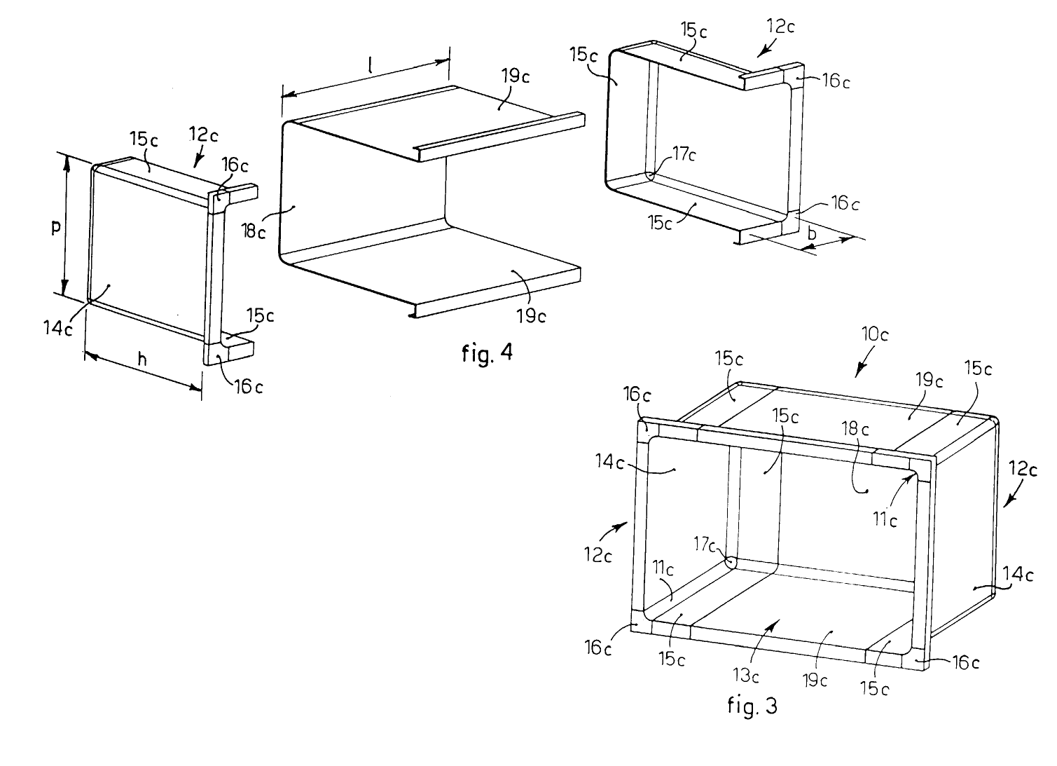

With reference to the attached drawings, FIGS. 1-4 show three different types of metal cells, indicated respectively by 10a, 10b, and 10c, for furniture obtainable with the present invention. The metal cells shown in FIGS. 1-4 correspond with respective different hygiene levels. To be more exact, the metal cell 10a in FIG. 1 corresponds to a hygiene level indicated by Hy1, and is made with components having bends with a sharp edge 11a only in the lower part; the metal cell 10b in FIG. 2 corresponds to a hygiene level indicated by Hy2, and is made with components having rayed bends 11b only in the lower part, while the metal cell 10c in FIG. 3 corresponds to a hygiene level indicated by Hy3, and is made with rayed bends 11c on all the inner edges of the cell.

Each metal cell 10a, 10b and 10c is made by assembling two flanks respectively 12a, 12b, 12c, and a central body 13a, 13b, 13c.

Each flank 12a, 12b, 12c is characterized by a finite, and advantageously limited, number of standardized sizes in terms of height h and depth p, while the overall width of the metal cell is defined by the length l of the central body 13a, 13b, 13c, which can vary substantially continuously from a minimum to a maximum value.

To give an example, the standardized values of height can be from 2 to 5, variable between about 500 mm and about 800 mm, the values of depth can be from 3 to 7, and variable between about 300 mm and about 900 mm, while the length l can vary as desired from about 300 mm to about 2500 mm.

In this way, with a limited number of standardized components and using the same type of working, only with a rapid modification of the configuration of the equipment (as will be seen better hereafter), it is possible to satisfy the requirements of the clients both in terms of size and also in terms of choosing the desired hygiene level.

Each flank 12a, 12b, 12c consists in turn of a base 14a, 14b, 14c, quadrangular in shape, normally rectangular, whose sizes h and p respectively define height and depth of the relative metal cell 10a, 10b and 10c, and of two (in the cases of FIGS. 1 and 2) or three (FIGS. 3 and 4) limbs 15a, 15b and 15c, of a standardized width, which are joined at the perimeter edges of the relative base 14a, 14b and 14c in the first step of production, as will be explained better hereafter.

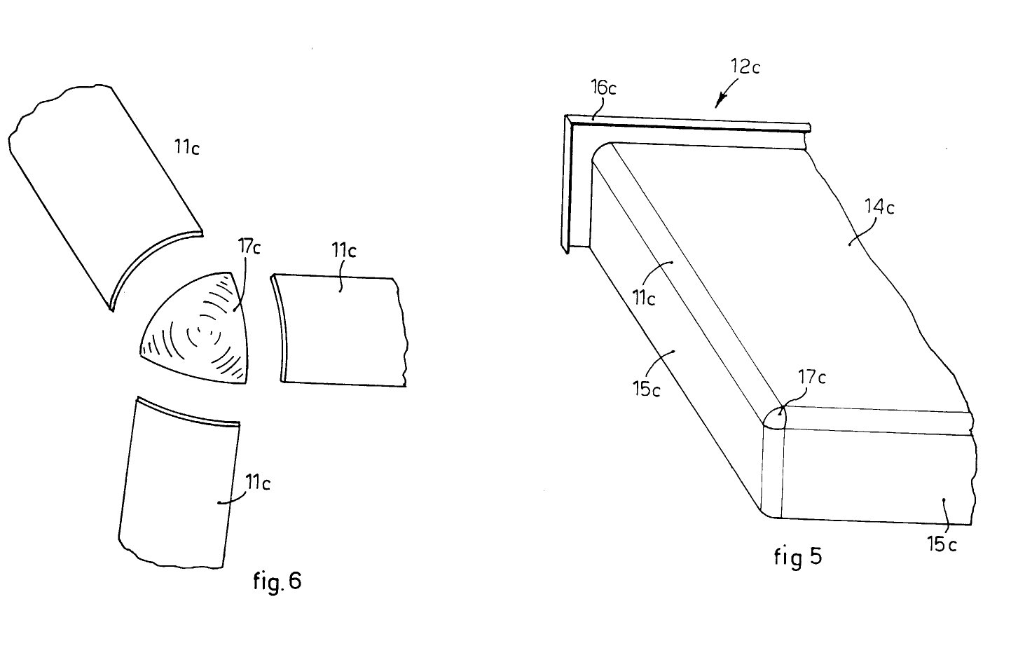

To complete it, each flank also comprises front corner elements 16a, 16b and 16c, and in the case of FIGS. 2, 3 and 4, semi-spherical corner elements 17b and 17c (FIGS. 5 and 6) which close the edge of the inner volume in the case of metal cells 10b and 10c having a hygiene level Hy2 and Hy3.

As can be seen from the figures, particularly FIGS. 1, 2 and 3, the weld made between the inner ends of the limbs 15a, 15b, 15c and the relative outer edges of the central body 13a, 13b and 13c allows to prevent discontinuous joining points from being formed in correspondence with the edges, which cause deposits and inclusions, thus obtaining an inner volume that is easy to clean and hence such as to ensure excellent hygiene conditions, particularly where the edges are rayed, as in the case of the solutions shown in FIGS. 2 and 3.

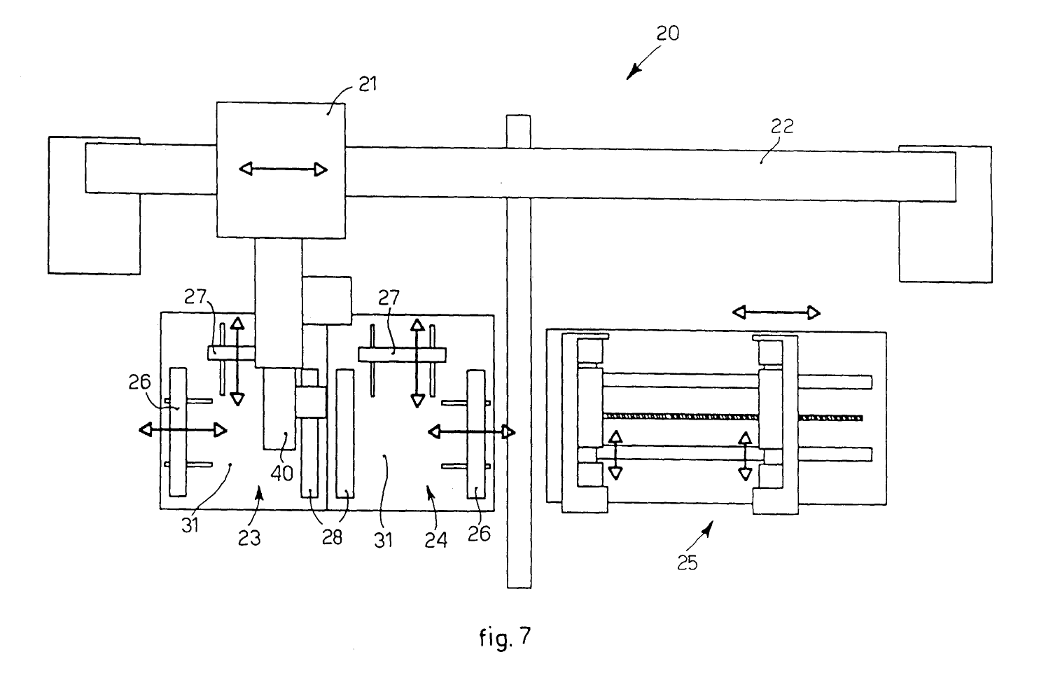

The central body 13a, 13b and 13c also has a quadrangular base 18a, 18b, 18c, with a height equal to the depth p of the base 14a, 14b, 14c of the relative flanks 12a, 12b, 12c, and one (solution shown in FIGS. 1 and 2) or two (solution shown in FIG. 3) limbs 19a, 19b, 19c with a width equal to the height h of the relative bases 14a, 14b, 14c. The metal cells 10a, 10b, 10c are made in an apparatus indicated in its entirety by the reference number 20 and shown schematically in FIGS. 7, 8 and 9.

The apparatus 20 consists of:

a robotic arm 21, which supports a welding tool 40 and is suspended on a beam 22 which allows it to be translated longitudinally in order to serve the various welding templates used in the process;

a first 23, a second 24 and a third 25 welding template. To be more exact, the first 23 and the second 24 welding templates are disposed adjacent to each other and are used to make a respective flank 12a, 12b, 12c, right and left, while the third welding template 25 is used to join the flanks 12a, 12b, 12c and the central body 13a, 13b, 13c.

Thanks to this configuration, while the two templates 23 and 24 are working to complete the flanks of a subsequent cell, the operations can be carried out to load or discharge the metal cell 10a, 10b, 10c already finished by the third welding template 25; or, while the third template 25 is working, the operations to load and discharge the templates 23 and 24 can be carried out; in this way the dead times are reduced to a minimum. It may also come within the framework of the invention to use two robotized welding arms 21 to further increase productivity.

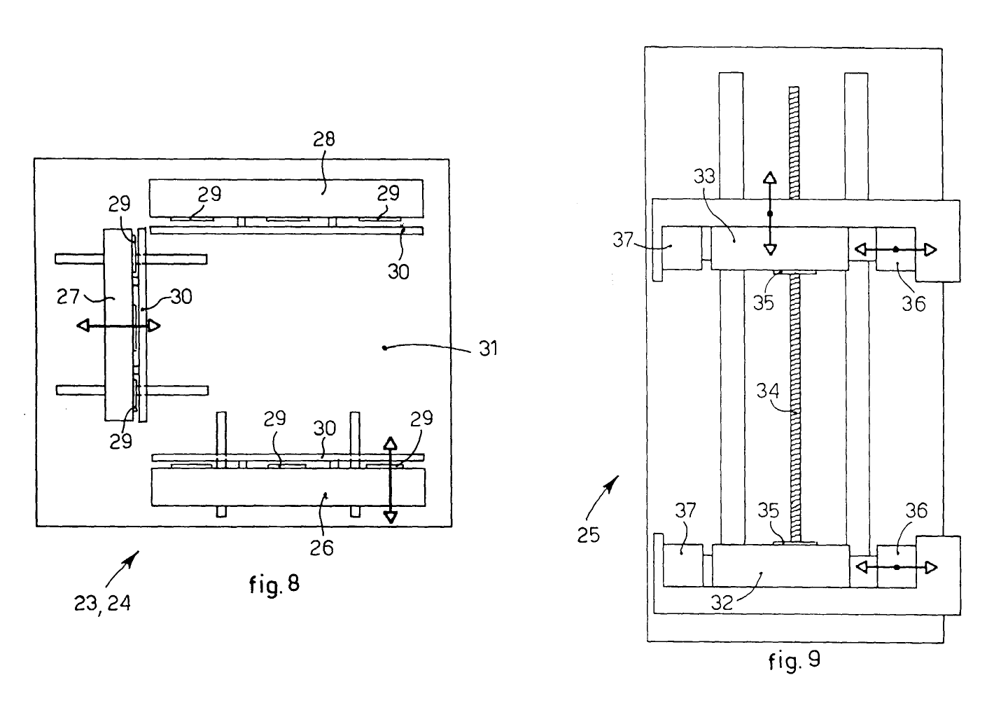

With reference to FIG. 8, each welding template 23 and 24 comprises:

a supporting base 31, which substantially defines the positioning area of the element to be welded;

two mobile parts disposed substantially perpendicular to each other, one lateral 26 and one bottom 27, and

a fixed part 28, disposed parallel to the lateral mobile part 26, which functions as a reference for the size of the metal cell 10a, 10b, 10c to be made.

Each part, whether fixed or mobile, comprises in this case and purely to give an example, a plurality of magnets 29 and a metal clamping plate 30. After positioning the parts of the flanks 12a, 12b, 12c to be welded in the space between the magnets 29 and the plates 30, the magnets 29 are activated to attract towards them the clamping plates 30, so as to clamp mechanically under pressure the elements to be welded. There is therefore a direct hybrid retention, mechanical/magnetic, of the components to be welded, that is, consisting of a mechanical clamping that uses the magnetic attraction exerted by the magnets 29.

The bottom mobile part 27 is disposed in an initial position at a determinate distance from the inlet edge of the supporting base 31 and comprises, in correspondence with each one of its ends, a seating able to possibly house the semi-spherical corner element 17b or 17c, which must be welded on the relative edge defined in the flanks.

The lateral mobile part 26 and the bottom mobile part 27 are moved by respective movement mechanisms which displace them, with respect to the fixed part 28, according to the values of height h and depth p of the flanks 12a, 12b, 12c.

The movement mechanisms are not shown in detail here since they are already known in the state of the art and are not relevant to understand the invention; they normally consist of an electric motor which drives a grub screw connected to the relative mobile parts 26, 27, and an encoder which detects the distance traveled by the relative mobile part 26, 27 and transmits it to the control unit of the motor so that the displacement is effected for the necessary value according to the data of size of height h and depth p of the metal cell 10a, 10b, 10c to be obtained.

The mobile parts 26, 27 are clamped in the desired position by means of a clamping device, also of a known type and not shown in detail here. An example can consist of pins that are driven by relative actuators and are inserted in suitable seatings made in the supporting base 31.

The third welding template 25 also comprises a fixed component 32 and a mobile component 33, substantially parallel to each other. Each of them is able to house a flank 12a, 12b and 12c, made previously in the templates 23 and 24, and part of the central body 13a, 13b, 13c, so that the ends of the limbs 15a, 15b, 15c of the relative flanks 12a, 12b, 12c and the perimeter edges of the central body 13a, 13b, 13c are in contact with each other.

The mobile component 33, which is associated with a movement mechanism of the type described above, comprising a grub screw 34, is distanced from or brought near the fixed component 32 according to the length l of the central body 13a, 13b, 13c. On the inner side too of the relative mobile 33 and fixed 32 components there are respective magnets 35 which cooperate with relative clamping plates (not shown here), identical to those mentioned for the templates 23 and 24, in order to mechanically clamp the components to be welded, particularly the limbs of the flanks and the central body, exploiting the attraction exerted by the magnets 35 on the relative plates.

The third welding template 25 also comprises mobile lateral elements 36 which are displaced laterally, in a direction substantially orthogonal to the direction of movement of the mobile part 33, with respect to corresponding fixed lateral elements 37, according to the depth p of the flanks and hence of the metal cells 10a, 10b, 10c to be made. A mobile lateral element 36 and a fixed lateral element 37 are mounted on the mobile part 33 and move together with it.

The method to make the metal cell 10a, 10b, 10c according to the invention comprises a first step in which the flanks 12a, 12b, 12c are completed and a second step in which the flanks 12a, 12b, 12c are welded to the central body 13a, 13b, 13c.

The first step comprises in sequence:

1. a step of first positioning, in which the mobile parts both lateral 26 and bottom 27 are displaced respectively according to the depth p and the height h of the flanks and clamped in the desired position corresponding to the data of size of the metal cell 10a, 10b, 10c input by the operator;
2. a step of second positioning, in which the semi-spherical corner elements 17b and 17c are disposed on the appropriate seatings made in the bottom mobile part 27;
3. a step of third positioning, in which every flank 12a, 12b, 12c is disposed on the corresponding welding template, for example the right flank in the first welding template 23 and the left flank in the second welding template 24;
4. a step of mechanical clamping of the limbs 15a, 15b, 15c of the flanks 12a, 12b, 12c against the magnets 29 of the mobile parts 26, 27 and the fixed part 28;
5. a first step of welding the limbs 15a, 15b, 15c of the flanks 12a, 12b, 12c.

In the third positioning step, each flank 12a, 12b, 12c is disposed with its base 14a, 14b, 14c resting on the supporting base 31 of the corresponding welding template 23, 24, while its limbs 15a, 15b, 15c are disposed between the clamping plates 30 and the relative magnets 29 of the mobile 26, 27 and fixed 28 parts.

At this point the first welding step occurs, in which the robotic arm 21 is disposed first above the first welding template 23 and then above the second welding template 24, performing the welding of the limbs 15a, 15b, 15c of the front corner elements and possibly of the semi-spherical corner elements 17b, 17c.

If the flanks 12a, 12b, 12c used have a hygiene level Hy1 or Hy2 (FIGS. 1 and 2), the lateral mobile part 26 of the welding template 23, 24 remains unused, since one limb of the flanks 12a, 12b, is disposed in correspondence with the fixed lateral part 28, while the other limb is disposed in correspondence with the bottom mobile part 27. Moreover, if the flanks used have a hygiene level Hy1, the semi-spherical corner elements 17b, 17c are not used.

The second step comprises, after the flanks 12a, 12b, 12c and the relative central body 13a, 13b, 13c have been loaded in the third welding template 25, the following steps:

6. a pre-positioning step of the mobile component 33;
7. a first positioning step of the flanks 12a, 12b, 12c on the mobile 33 and fixed component 32;
8. a second step to bring the mobile component 33 near the fixed component 32 according to the length l of the central body 13a, 13b, 13c;
9. a third positioning step of the central body 13a, 13b, 13c on the two components 32, 33;
10. a fourth step to mechanically clamp the limbs 15a, 15b, 15c of the flanks 12a, 12b, 12c and the central body 13a, 13b, 13c on said magnets 35;
11. a second welding step by means of displacing the mobile arm 21.

When welding is completed, the finished metal cell 10a, 10b, 10c can be removed from the template 25.

It is clear that modifications and/or additions of parts or steps may be made to the apparatus and the method as described heretofore, without departing from the field and scope of the present invention as defined in the attached claims.

For example, instead of the magnets 29 and 35 and the clamping plates 30, other clamping devices of a known type may be used, for example sucker devices or snap-in mechanical elements.

It is also clear that, although the present invention has been described with reference to some specific examples, a person of skill in the art shall certainly be able to achieve many other equivalent forms of apparatus and method to make a metal cell for furniture, having the characteristics as set forth in the claims and hence all coming within the field of protection defined thereby.

1. Metal A metal cell for furniture, comprising
two flanks and a central body located between them, wherein each of said flanks has a first polygonal base with standardized height (h) and depth (p) according to a finite number of values, and at least two limbs made on two consecutive sides of said first polygonal base, substantially orthogonal thereto and having two ends disposed near each other, said central body having a second polygonal base, with a height equal to the height (h) of said first polygonal base and at least a limb made on one side of said second polygonal base, and wherein said first and second limb of said flanks are welded together in correspondence with their close ends, an external edge of a first of said limbs is welded to a perimeter edge of said limb of said central body and an outer edge of a second of said limbs is welded to a perimeter edge of said second polygonal base of said central body.

2. (canceled)

3. A metal cell as in claim 1, wherein a rayed connection zone is made both between said limbs and said polygonal base of said flanks, and also between said limb and said polygonal base of said central body.

4. A metal cell as in claim 3, wherein at least a semi-spherical connection element is welded in correspondence with the edge of the inner volume of said flanks defined in the intersection between two rayed surfaces of a limb and the relative polygonal base.

5. A metal cell as in claim 1, wherein said at least two limbs have a length comprised between 10 mm and 250 mm.

6. An apparatus (to make a metal cell as in claim 1, comprising
a first welding unit defining a first welding zone, able to house at least one of said flanks in order to attach to each other at least a first and a second limb in correspondence with the respective ends, a second welding unit defining a second welding zone, able to house said flanks and said central body in order to attach both a first limb of said flanks to a second polygonal base of said central body, and a second limb of said flanks to a relative limb of said central body, at least a welding device being selectively mobile between said first and said second welding unit according to the welding step in progress.

7. An apparatus as in claim 6, wherein said first welding unit comprises a supporting base on which said flank is rested, at least a fixed part and at least a mobile part disposed around said supporting base, said mobile part being able to be displaced in order to accommodate and retain said flank in said first welding zone, according to said height (h) and said depth (p) of said first polygonal base.

8. An apparatus as in claim 7, wherein said mobile part comprises, in correspondence with its ends, a seating able to accommodate said one semi-spherical connection element, so that said first welding unit is able to accommodate said flank having any level of hygiene.

9. An apparatus as in claim 7, wherein each of said mobile and fixed parts comprises, facing towards the supporting base, a plurality of magnets and a metal clamping element, disposed opposite said magnets at a certain distance therefrom and able to be attracted by the latter in order to clamp said limbs of said flanks against the corresponding one of said fixed and mobile parts.

10. An apparatus as in claim 6, wherein said second welding unit comprises two components opposite each other of which one is mobile and one is fixed, able to house a corresponding one of said flanks and part of said limb and also said second polygonal base of said central body.

11. An apparatus as in claim 10, wherein said mobile component is able to be positioned with respect to said fixed component according to the length (l) of said central body.

12. An apparatus as in claim 10, wherein each of said fixed and mobile components comprises on its inner side a plurality of magnets and a second clamping element, disposed opposite said magnets so as to be attracted by the latter so as to mechanically clamp both said limbs of said flanks and also part of said limb and said second polygonal base of said central body against the corresponding fixed or mobile component.

13. An apparatus as in claim 6, wherein said welding device comprises a robotic arm, provided with a welding tool and able to slide on a beam between said first welding unit and said second welding unit.

14. A method to make a metal cell as in claim 1 in an apparatus which comprises a first welding unit defining a first welding zone, able to house at least one of said flanks in order to attach to each other at least a first and a second limb in correspondence with the respective ends, a second welding unit defining a second welding zone, able to house said flanks and said central body in order to attach both a first limb of said flanks to a second polygonal base of said central body, and a second limb of said flanks to a relative limb of said central body, at least a welding device being selectively mobile between said first and said second welding unit according to the welding step in progress, the method comprising a first step in which said flanks of said metal cell are made and a second step in which said flanks are welded to said central body, wherein said first step comprises at least a step of first positioning, wherein a lateral mobile part and/or a bottom mobile part of said apparatus are displaced, according respectively to the depth (p) and also to the height (h) of said flanks and clamped in the desired position corresponding to the data of size of the metal cell as input by an operator.

15. A method as in claim 14, wherein for the metal cells including rayed bends in their inner volume, said first step also comprises a step of second positioning, wherein at least a semi-spherical connection element is welded in correspondence with the edge of the inner volume of said flanks defined in the intersection between two rayed surfaces of a limb and the relative polygonal base.

16. A method as in claim 14, wherein said first step comprises a step of third positioning, wherein each flank is disposed on the corresponding first welding unit, a step of mechanical clamping of the limbs of the flanks against the magnets of the mobile parts and the fixed part of said first welding unit and a first step of welding the limbs of the flanks, the front corner elements and possibly the semi-spherical connection elements.

17. A method as in claim 14, wherein said second step comprises the loading of the flanks and the relative central body into said second welding unit and, in sequence, the following steps:
a pre-positioning step of a mobile component of said apparatus;
a positioning step of the flanks on the mobile component and fixed components of said apparatus;
a step to bring the mobile component near the fixed component according to the length (l) of the central body;
a positioning step of the central body on the two components
a step to mechanically clamp the limbs of the flanks and the central body on magnets;
a welding step of the limbs of said flanks, the limbs of said central body and the base of said central body by means of displacing the mobile arm towards said second welding unit.
